(19) United States
(12) Patent Application Publication
(10) Pub. No.: US 2013/0111736 A1
(43) Pub. Date: May 9, 2013

(54) METHOD FOR PREPARING A MATERIAL FOR STORING HYDROGEN, INCLUDING AN EXTREME PLASTIC DEFORMATION OPERATION

(71) Applicants: Daniel Fruchart, Meylan (FR); Salvatore Miraglia, Grenoble (FR); Patricia De Rango, Gieres (FR); Nataliya Skryabina, Perm (RU); Michel Jehan, Fessy (FR); Jacques Huot, Trois-Rivieres (CA); Julien Lang, Edmunston (CA); Sylvain Pedneault, Trois-Rivieres (CA)

(72) Inventors: Daniel Fruchart, Meylan (FR); Salvatore Miraglia, Grenoble (FR); Patricia De Rango, Gieres (FR); Nataliya Skryabina, Perm (RU); Michel Jehan, Fessy (FR); Jacques Huot, Trois-Rivieres (CA); Julien Lang, Edmunston (CA); Sylvain Pedneault, Trois-Rivieres (CA)

(73) Assignees: CENTRE NATIONAL DE LA RECHERCHE SCIENTIFIQUE, Paris (FR); UNIVERSITE DU QUEBEC A TROIS-RIVIERES, Trois-Rivières (CA); MCPHY ENERGY, La Motte Fanjas (FR)

(21) Appl. No.: 13/809,999

(22) PCT Filed: Jul. 11, 2011
(86) PCT No.: PCT/FR11/00409

§ 371 Date: Jan. 14, 2013

(30) Foreign Application Priority Data
Jul. 12, 2010 (FR) 1002928

(51) Int. Cl. C01B 3/00

(52) U.S. Cl. CPC C01B 3/0031; C01B 3/0026
USPC 29/527.4

(57) ABSTRACT

A material for storing hydrogen is prepared by a method including an extreme plastic deformation operation selected from cold-rolling, quick-forging and extrusion-bending performed on a metallic material selected from among a metal and an alloy containing said metal, or on a compound containing a metal material selected from among a metal and an alloy containing said metal and to which a hydride of said metal or a hydride of said alloy has been added. When the extreme plastic deformation operation is carried out on the metallic material, it is followed by an operation of adding, to the metal material, a hydride of said metal or a hydride of said alloy, as well as by a dispersing operation.

### BACKGROUND

The present disclosure relates to a method for preparing a material suitable for storing hydrogen, that is, a material which enables, either directly, or after at least one activation step, to absorb hydrogen for purposes of storage, transport and/or production thereof. Advantageously, the material capable of storing hydrogen is a material capable of reversibly storing hydrogen, that is, it can also desorb hydrogen under certain conditions.

### DISCUSSION OF THE RELATED ART

Hydrogen is used for various industrial chemical applications, such as the production of ammonia, refining, the forming of plastics, etc. Hydrogen may also advantageously be used as fuel (thermal motors, fuel cells), since it only produces water during its fast or slow combustion, and releases no greenhouse gas.

In view of its volume in the gaseous state and its explosibility, hydrogen should however be stored in a compact and secured form. A storage in the form of metal hydrides, in particular reversibly, fulfills these criteria. Indeed, in a metal hydride and under adapted pressure and temperature conditions, hydrogen incorporates in atomic form in the crystal lattice of the material. The hydrogen thus stored is then recovered when the pressure is lowered or when the temperature is increased. The quantity of hydrogen which can be thus absorbed and desorbed in the metal hydride is defined as being the reversible storage capacity and it expresses as the ratio, in percentage, of the hydrogen mass to the metal alloy mass.

A major problem to be solved for the synthesis of metal hydrides is that of the first hydriding (or first operation of hydrogen absorption in the metallic material), commonly called activation phase or first hydrogenation operation. Indeed, currently, the metal or the metallic alloy, which has never been hydrogenated, has to be submitted to hydrogen temperature and pressure conditions higher than usual thermodynamic equilibrium conditions, to form the corresponding hydride. This phenomenon is partly explained by the presence of surface oxides or of any other chemical surface barrier, having its thickness depending on the metal or alloy synthesis method. For example, this surface oxide acts as a barrier against the diffusion of hydrogen, which must be broken to put the metal surfaces in contact with gaseous hydrogen. Obviously, in industrial processes, it is practically impossible to have a large-volume synthesis generating no surface oxides. The first hydrogenation(s) or activation(s) should thus be performed at higher hydrogen pressure and at higher temperature than that (those) of the normal thermodynamic behavior, to force the hydrogen through the surface barrier. The insertion of the hydrogen atom into the metal network then increases the volume thereof, which then returns to its original value when the hydrogen atoms are extracted from the network in the dehydrogenation phase. Thus, in a hydrogenation/dehydrogenation cycle (or activation cycle), the crystal lattice also undergoes a volume expansion/contraction cycle which imposes mechanical stress breaking the crystallites or elementary metal particles. This indeed decreases the particle size, increases the specific surface area in contact with molecular hydrogen and in particular exposes fresh metal surfaces, free of surface oxide. Further, the activation process induces generally anisotropic deformations in the crystal lattice, as well as the creation of many dislocations and defects in the crystallites. A hydride itself prepared by a conventional method, that is, typically, during direct gas-metal reactions which may be slow or very slow, is improved, in terms of activation, by being submitted to several hydrogenation/dehydrogenation cycles, to also induce deformations in its crystal lattice and defects in the crystallites.

Certain metallic materials, such as magnesium, which has a large hydrogen storage capacity (7.6% by weight), are particularly difficult to activate. The conventional magnesium activation method has in particular been mentioned by E. Bartman et al. Chem. Ber. 123 (1990) p. 1517. This method consists in introducing a magnesium powder in an autoclave. The autoclave is then drained twice and pressurized to 3 bars of hydrogen. The pressure is then increased to 5 bars and the autoclave temperature is increased to 345° C. Once the 345° C. temperature has been reached, the hydrogen pressure is increased to 15 bars and maintained constant until the magnesium has been fully hydrogenated, for a total reaction time of more than 24 hours.

Since the conditions (temperature, pressure, duration) necessary to implement such a magnesium activation method are quite constraining, some have attempted to ease this activation step, by especially using catalysts. For example, patent U.S. Pat. No. 5,198,207 proposes to add to the magnesium powder a quantity of 1.2% by weight of magnesium hydride as a catalyst, during the activation operation, that is, in the presence of hydrogen. Said operation is, in particular, performed on the Mg+MgH₂ mixture for more than 7 hours, at a temperature higher than or equal to 250° C. and under a hydrogen pressure ranging between 5 bars and 50 bars, with a constant stirring.

Certain activation methods use a mechanical grinding under a hydrogen atmosphere. As an example, Chen, Y et al (“Formation of metal hydrides by mechanical alloying” J. of Alloys and Compounds, 1995. 217: pp. 181-184) have shown that a high quantity of magnesium hydride is generated when magnesium is ground under a 2.4-bar hydrogen atmosphere, for more than 47 hours. A similar experiment has been made by Bobet et al in the article “Synthesis of magnesium and titanium hydride via reactive mechanical alloying. Influence of 3d-metal addition on MgH₂ synthesis” (J. of Alloys and Compounds, 2000. 298: pp. 279-284) which have demonstrated that the addition of a catalyst, such as cobalt, improves the hydrogenation during an activation under hydrogen, accompanied by a mechanical grinding. However, the authors have observed that approximately ⅔ only of the magnesium was hydrided for a 10-hour grinding. In patent U.S. Pat. No. 6,680,042, materials suitable for storing hydrogen, such as magnesium, are hydrided by mechanical grinding under a hydrogen atmosphere at high temperature (300° C.), in the presence of a hydrogenation activator such as graphite. With this technique, it is possible to obtain a hydrogenation within one hour.

It has also been proposed to perform the mechanical grinding before the magnesium activation. Thus, Imamura et al, in article “Hydriding-dehydriding behavior of magnesium composites obtained by mechanical grinding with graphite carbon” (International J. of Hydrogen Energy 25 (2000) 837-843. 5198207.) have shown that when the magnesium powder is ground with graphite, in the presence of cyclohexane (CH) or of tetrahydrofurane (THF) with or without a catalyst (Pd), the obtained composite is hydrogenated more rapidly than magnesium alone, when the mixture, once mechanically ground, is exposed to a 0.7-bar hydrogen atmosphere, at 180° C. The magnesium ground with graphite alone, without CH or THF, only absorbs 5% by weight of hydrogen in 20 hours. However, when cyclohexane is added to the mixture during the grinding, 80% of the magnesium is converted into hydride in 20 hours of grinding.

These various methods decrease the duration of the first hydrogenation by submitting the magnesium to a high-energy grinding with or without the presence of additives and with a grinding that may be performed under a hydrogen atmosphere and at high temperature. However, most of these methods have only been tested at a laboratory scale and the production of industrial quantities by one or the other of these methods has not been demonstrated.

The development of industrial equipment capable of performing a high-intensity grinding under a hydrogen atmosphere and at high temperature (>300° C.) brings about many technological challenges and raises important security issues, in particular for magnesium, which is very reactive (pyrophoric) in the very fine powder state resulting from an extensive grinding.

### OBJECT OF THE INVENTION

The present invention aims at providing a novel method for preparing a material suitable for storing hydrogen, preferably reversibly, with an eased industrial implementation, the kinetics and the hydrogen absorption rate being advantageously increased in said material.

According to the present invention, this aim is achieved by the appended claims.

### BRIEF DESCRIPTION OF THE DRAWINGS

Other advantages and characteristics will more clearly arise from the following description of particular embodiments of the invention given as nonrestrictive examples and represented in the annexed drawings in which:

FIG. 1 illustrates in the form of a block diagram two possible embodiments according to the present invention for the synthesis of a hydrogen storage material containing magnesium.

FIG. 2 is a diagram showing the first-order absorption kinetics for a material prepared according to a first embodiment of the present invention (curve 1) and according to two conventional methods given as a comparison (curves 2 and 3).

FIG. 3 is a diagram showing the kinetics of the first and second absorption and desorption cycles of samples prepared according to a second embodiment of the present invention (curves a and a′, b and b′) and of samples prepared according to conventional methods given as a comparison (curves c, c′; d, and e, e′).

FIG. 4 is a diagram showing the kinetics of the first and second absorption and desorption cycles of samples prepared according to a third embodiment of the present invention (curves a and a′, b and b′) and of samples prepared according to conventional methods given as a comparison (curves c, c′; d, d′).

### DESCRIPTION OF SPECIFIC EMBODIMENTS

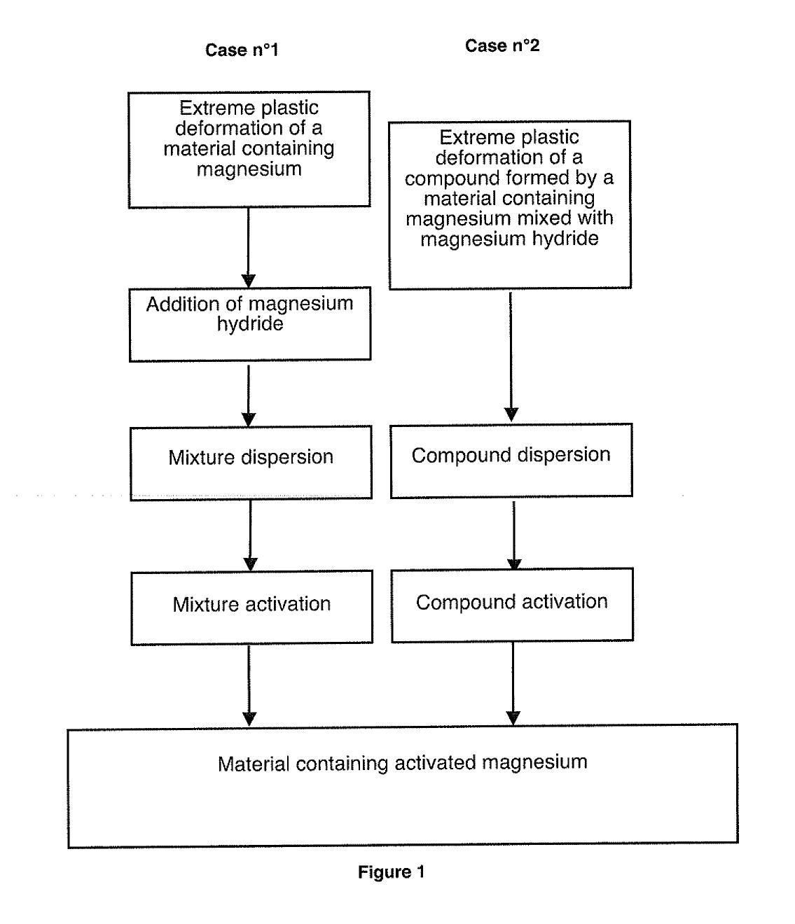

As illustrated in FIG. 1, it has been discovered, surprisingly, that it is possible to prepare a material containing magnesium particularly suitable for reversibly storing hydrogen, by submitting a metallic material containing magnesium to a main extreme plastic deformation operation (case n° 1 in FIG. 1), and by then adding a hydride to said metallic material and performing a dispersion. The dispersion may advantageously be performed in an inert atmosphere. “Inert atmosphere” is used to designate an atmosphere without any gases capable of reacting with the material intended to be dispersed and especially a hydrogen-free atmosphere. The inert atmosphere advantageously is an argon atmosphere.

Advantageously, the metallic material containing magnesium is substantially pure magnesium or an alloy containing magnesium, such as a low-alloyed magnesium. Further, it is advantageously in non-pulverulent form, for example; in the form of a solid piece, such as an ingot, a bar, or sheets.

The extreme plastic deformation operation is selected from among cold-rolling, quick-forging and extrusion-bending, which are three particularly advantageous techniques for implementing the preparation method at an industrial scale. Such an operation further is a mechanical operation releasing a high mechanical power, which is, as known by those skilled in the art, very different from the prior art ball-milling operation, which has a mechanical power much lower than that of extreme plastic deformations used in the context of the present invention.

Further, in this first embodiment (case n° 1 in FIG. 1) comprising performing an extreme plastic deformation operation on the material containing magnesium, this operation is followed by an operation of addition of a hydride and by a dispersion operation.

The added hydride is selected to contain at least the same metal as the metal comprised in the metallic material. The metallic material being, in particular, made of a metal or of an alloy containing said metal, the hydride is selected so as to be a hydride of said metal or a hydride of said alloy. Thus, for a metallic material containing magnesium, it may be a magnesium hydride or a hydride of an alloy containing magnesium. Further, the hydride proportion added to the metallic material is more specifically in minority with respect to the proportion of metallic material. The proportion of hydride added to the metallic material preferably ranges between 0.5% and 10% by weight with respect to the total weight of said metallic material, and advantageously between 1% and 5%. Finally, the added hydride may be a hydride obtained by conventional solid-gas-type conventional synthesis, that is, with particularly slow hydrogen absorption and desorption reactions. It may however also be a hydride obtained by activation of the magnesium or of the alloy containing magnesium (first hydrogenation phase to activate the material), for example, in conditions similar to those described in the previously mentioned article of E. Bartman et al.

In FIG. 1, the addition operation of the hydride to the metallic material containing magnesium is performed before the dispersion operation. In this case, the dispersion operation is an operation of dispersion of the mixture obtained during the addition of the hydride to the metallic material. However, the addition of the hydride to the metallic material may also be carried out during the dispersion operation. In this second case, the dispersion operation enables to disperse first the metallic material, and then the mixture obtained during the addition. In both cases, the dispersion operation enables to refine the grain size distribution of the metallic material and to obtain a good dispersion between the metallic material and the hydride.

Such a dispersion operation may advantageously be a mechanical grinding carried out for a time shorter than or equal to one hour and advantageously for approximately 30 minutes.

As illustrated in FIG. 1, once the mixture dispersion operation has been performed, for example under an inert atmosphere, the mixture is more specifically submitted to the first hydrogenation operation, in an autoclave, to activate the metallic material. Before this first hydrogenation operation, the mixture may first be dehydrogenated to desorb the hydrogen from the previously added hydride.

In this embodiment (case n° 1), the hydride has been added after the extreme plastic deformation operation. It may be envisaged, as shown by case n° 2 of FIG. 1, to add the hydride to the metallic material before the extreme plastic deformation, rather than after it. In this case, the material submitted to the extreme plastic deformation is formed of a compound comprising the metallic material containing magnesium and said hydride. As in case n° 1, the added hydride is selected to contain at least the same metal as the metal used to make the metallic material. The hydride thus is a hydride of said metal or a hydride of an alloy containing said metal. Further, as in case n° 1, the proportion by weight of hydride added to the metallic material containing magnesium is in particular in minor proportion with respect to the total weight of said metallic material. Advantageously, the proportion of hydride added to the metallic material containing magnesium preferably ranges between 0.5% and 10% by weight with respect to the total weight of said metallic material and advantageously between 1% and 5%. Finally, the added hydride may be a hydride obtained by conventional solid-gas-type synthesis, that is, with particularly slow hydrogen absorption and desorption reactions. It may however also be a hydride obtained by activation of the magnesium or of the alloy containing magnesium (first hydrogenation phase to activate the material), for example, under conditions similar to those described in the previously mentioned E. Bartman et al.'s article. Further, the compound submitted to the extreme plastic deformation is preferably in the form of a solid piece, for example, obtained by compacting the metallic material to which the hydride has been previously added. Said metallic material, before the addition of hydride and the forming of the compound, may itself have been submitted to an extreme plastic deformation. In this case, this operation may be consecutive to the extreme plastic deformation performed on the compound. Hydride is then added during an extreme plastic deformation operation comprising the one performed on the metallic material alone and the one performed on the compound. As a variation, it may also be sequential with an interruption to add the hydride and form the compound. Further, as in case n° 1, the compound having been submitted to the extreme plastic deformation operation selected from among cold-rolling, quick-forging and extrusion-bending is then advantageously submitted to an operation of dispersion of said compound, for example, in an inert atmosphere, and/or to a first hydrogenation operation to activate said compound.

It has been observed that a method implementing a main operation of extreme plastic deformation selected from among cold-rolling, quick-forging, and extrusion-bending on a metallic material containing magnesium, associated with the (prior or subsequent) addition of a quantity (preferably in minority) of hydride comprising magnesium enables to provide a novel method for preparing a material suitable for storing hydrogen, which can be industrialized and is easy to implement. Further, the addition of hydride, before the activation phase, enables to increase the hydrogen absorption and desorption kinetics during the cycles following the activation of the material. It also enables to obtain a high absorbed hydrogen rate, close to the theoretical maximum mass absorption value.

Three embodiments have been implemented to illustrate the present invention.

According to a first embodiment of the present invention, a magnesium ingot sold by Norsk Hydro, with a 99.99% purity, has been submitted to an operation of extreme plastic deformation by cold rolling. The cold-rolling operation has been performed by a plurality of successive passes through a Durston rolling mill, having rolls of a 50-mm diameter. The magnesium ingot is in the form of a plate having a 0.5-mm thickness before the rolling. Further, after each pass between the rolling mill rolls, the plate was folded in two before its next pass through the rolling mill. The thickness decrease thus was 50% for each rolling. Further, the rolling operation has been performed in ambient air.

After 50 successive passes through the rolling mill, the magnesium has been mixed with 5% by weight of magnesium hydride (Sigma Aldrich, 99% purity). The mixture has then been submitted to a step of dispersion by mechanical grinding, by using a model SPEX grinder, for 30 minutes, in a crucible under an argon atmosphere.

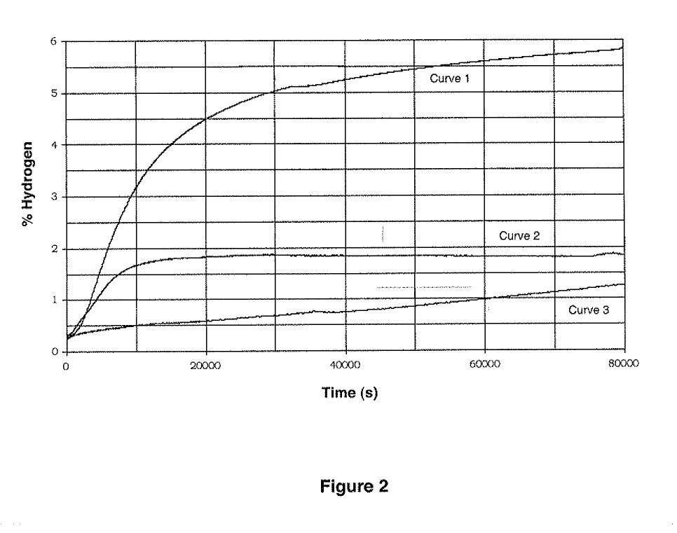

After the grinding, the ground mixture has been placed in a reactor coupled with a system for measuring the hydrogen quantity. The reactor has first been heated up to 350° C. while continuously pumping. This step enables to desorb the additional MgH₂. The Mg particles thus obtained will be used as a nucleation point for the entire material during the next hydrogenation phase. This desorption step has lasted for approximately 3 hours. A 20-bar hydrogen pressure has then been applied to the sample and the quantity of absorbed hydrogen has been measured along time, as shown by curve 1 (sample 1) in FIG. 2.

As a comparison, a non-rolled and non-ground magnesium sample (sample 2) has been hydrogenated in the same way (curve 2 in FIG. 2). In this case, the absorption stops at approximately 1.8% by weight. This is probably due to the fact that the hydrogenation is only performed at the surface of the magnesium particles. Once the surface has been hydrogenated, the external hydrogen must then diffuse through the surface hydride phase of the magnesium, which is very slow. Further, another sample (sample 3) has been submitted to the same preparation steps as sample 1, except for the addition of magnesium hydride. As compared with curve 1, curve 3 illustrating the first hydrogenation of said sample in FIG. 2 shows that the hydrogen absorption is very slow for sample 3. Thus, the fact of adding a small quantity of magnesium hydride to the magnesium ingot and of performing a strong mechanical grinding of the mixture enables the hydrogen migration to benefit from the effects of extreme plastic deformation of the material here processed in the solid state. Further, the proportion of hydrogen absorbed during the first hydrogenation is much greater for sample 1 as compared to samples 2 and 3.

According to a second embodiment, industrial-type magnesium alloy bars of AZ31 (or ZK60) type have been submitted to a step of extreme plastic deformation by equal channel angular pressing (ECAP).

Alloys AZ31 or ZK60 are called construction alloys, generally used for their to mechanical properties resulting from the addition of additive metals in small quantities. Alloy AZ31 contains approximately 3% of Al and 1% of Zn, while ZK60 contains approximately 6% of Zr. Such alloys are current products used for light construction techniques (especially, avionics, automobile industry) and have a very advantageous cost. They further have strong mechanical properties, which are used for the implementation of extreme plastic deformation techniques, and in particular ECAP, which is one of the most constraining from a metallurgic viewpoint.

Several extrusion methods may be implemented with the ECAP according to whether the extruded bar is rotated around its axis (extrusion direction) between two successive passes or not. In the method used according to the second embodiment, the ECAP head has been designed by company ‘Poinsard Design’ (Besancon, France), with a 30-ton press developed by company ‘La Savoisienne de Vérins’ (Alberville, France). Further, the alloy bars had the following dimensions: 11×11×70 mm. They have been passed several times by ECAP extrusion according to the mode called A (with no rotation) or the mode called Be (with a 90° rotation between each pass). The angle of the die bending is adjustable and has been selected to be close to 90° (exactly 105°) to provide a maximum deformation in practical operating conditions. The first mode used is an anisotropic deformation mode since the effect of extreme deformations is successively cumulated, the second mode is an isotropic mode since the effect of extreme plastic deformations is alternated by rotation of the bar. The ECAP extrusion has been performed at different temperatures (from the ambient temperature to 300° C.), due to an auxiliary device and for a number of passes varying from 1 to 15 (duration of an extrusion <1 second without taking into account the manipulation time for placing back the bar into the inlet die). All the operations have been performed in ambient air, including the heating up of the bars. The operating temperature has been optimized afterwards between 175° and 225° C. according to the plastic/ductile properties of the considered alloy. After, the number of successive passes has been usefully decreased to 3 or even 2 passes.

The alloy bars thus treated by extreme plastic deformation of ECAP-type have become very brittle (hand-breakable) and have been mixed with 5% by weight of magnesium hydride (Sigma Aldrich, 99% purity). The mixture has then been mechanically ground by using a model-SPEX 8000 grinder for a duration from 30 to 60 minutes, in a crucible under an argon atmosphere. After grinding, the ground mixture has been placed in a reactor and treated according to the hydrogenation procedure described in the first embodiment.

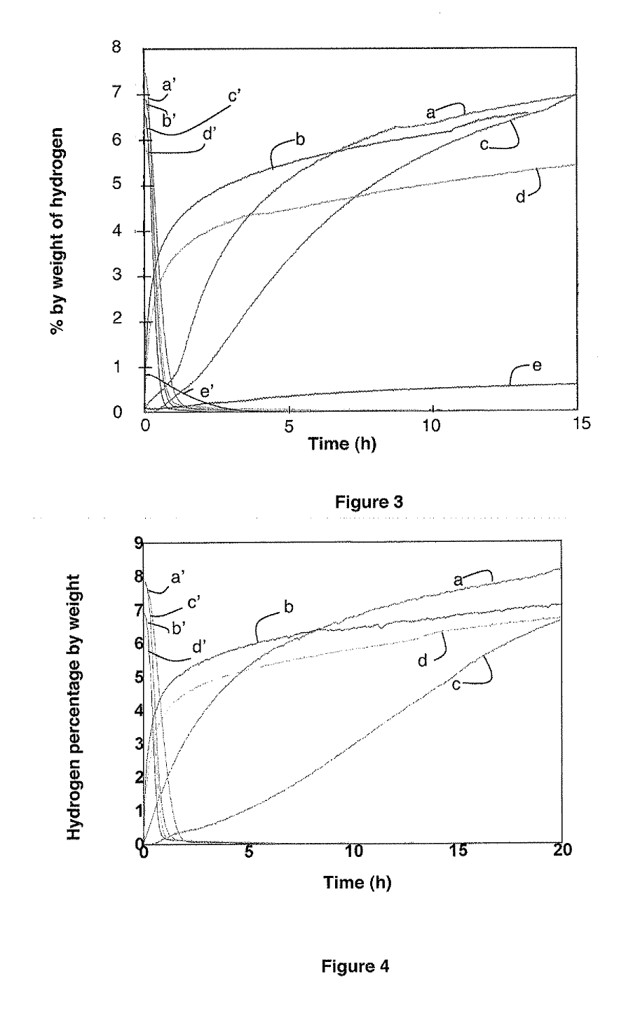

FIG. 3 shows the first and second absorption and desorption cycles, under 20 bars of hydrogen pressure, of the AZ31 sample, which have been submitted to an ECAP (pathway A, 8 times) and then inoculated by MgH₂ additive and mechanically ground for 30 minutes (curves a and b, respectively, for the first and second absorption cycles and curves a′ and b′, respectively, for the first and second desorption cycles). As a comparison, the same curves have been plotted for same AZ31 samples submitted to an ECAP, but non inoculated and also submitted to a mechanical grinding (curves c and d for the 1^{rst} and 2^{nd} absorption cycles and c′ and d′ for the 1^{rst} and 2^{nd} desorption cycles) and finally for the same AZ31 sample not submitted to the ECAP, non inoculated and non processed (lines e and e′). Although the curves of desorption performed under vacuum and at 300° C. are naturally tighter, they reflect the same advantageous disposition than the one for samples having been submitted to the same operations performed according to the method of the second embodiment as compared with the two other samples.

Similarly, the curves plotted in FIG. 4 enable to compare the first and the second cycles of absorption under 20 bars of hydrogen pressure, then of desorption of AZ31 samples submitted to an ECAP (pathway Bc, 3 times), and then inoculated with MgH₂ additive by a SPEX mechanical grinder for 30 minutes (lines a and b and a′ and b′) as compared with the same samples not submitted to the ECAP and non inoculated but mechanically ground (lines c and d and c′ and d′).

The reactions are extremely slow when the alloy has been submitted to no treatment. They also remain slow when the material has been simply mechanically ground, with no inoculation, whether or not it has been treated by extreme plastic deformation.

As shown in FIGS. 3 and 4, the comparison between pathway of type A (anisotropic deformation) or Bc (isotropic deformation) for the initial extreme plastic deformation operation (SPD ECAP) also reveals an initial difference in the beginning of the hydrogenation with a nucleation stage marking the method using pathway A. It should also be noted that during the first hydrogenation, the theoretical maximum 7.6% load is reached.

Such results, as for the cold rolling (CR) method of the first embodiment, demonstrate the unexpected synergy of the effects of the initial extreme plastic deformation and of the MgH₂ inoculation, which provides much better results than all previously known and operated methods.

According to a third example, bars of magnesium alloy of AZ31 (or ZK60) type or of pure industrial magnesium have been very quickly forged by a drop-hammer press. The drop-hammer press comprises a 150-kg mass capable of freely falling from a variable height capable of reaching 1.5 meter above a piston penetrating into a work chamber. The mass then hits the sample placed on a fixed support at the internal base of said work chamber. In the method used, the quick forge is formed of a lifting arm according to a device designed by company Rabaud (Sainte Cecile, France). The forged sample may be heated up to a temperature adapted to the mechanical properties of the alloy or of the metal (for example, close to the fragile ductile behavior, which temperature has besides been determined) by an induction loop conducting a high-frequency electric current (generator of brand Céles). The forging chamber may then be placed in vacuum, under a neutral gas or again in the ambient atmosphere, according to the selected temperature and operating mode. Extreme plastic deformation processes may be recorded during the forging due to an optical window and a high-speed camera placed outside. This ensures quick forging conditions capable of developing, in the crystal lattice, a high density of generally anisotropic deformations, the creation of many dislocations and defects in crystallites and the decrease of the crystallite size to submicrometric dimensions, when the forging speed is at least 10 m/s, and the ingot size decrease on forging typically is ⅕, and preferably 1/10.

The material thus forged is then processed as in the first and second previously-described embodiments. 5% by weight of magnesium hydride (Sigma Aldrich, pure to 99% or McPHy-Energy, pure to 99%) are added to the material after the quick forging has been performed. The mixture has then been mechanically ground by using a model-SPEX 8000 grinder during 30 to 60 minutes, in a crucible under argon atmosphere. After grinding, the ground mixture has been placed in a reactor and treated according to the hydrogenation procedure described in the first embodiment. The obtained hydrogenation and dehydrogenation curves are quite similar to those plotted in FIG. 3 of the previous example and for the AZ31 reference alloy, and comparing the first and the second cycles of absorption under 20 bars of hydrogen pressure, then of desorption of the sample.

The above examples have been carried out with magnesium or with magnesium alloys. However, such a method for preparing a material suitable for storing hydrogen may be used with other metallic materials than magnesium and alloys containing magnesium. In particular, the material suitable for storing hydrogen may be an alloy containing aluminum. It may more generally belong to one of the following non-limiting groups:

1) elements selected from among Li, Be, B, Na, Mg, Si, K, Ca, Sc, Ti, V, Cr, Mn, Ni, Cu, Zn, Ga, Rb, Sr, Y, Zr, Nb, Pd, Cs, Ba, La, Hf, Ta, Ce, Pr, Nd, Sm, Gd, Tb, Dy, Ho, Er, Tm, Yb, Lu, Ac, Th and U.

2) AB₅-type alloys where:
A is at least one element selected from among La, Ca, Y, Ce, Mm, Pr, Nd, Sm, Eu, Gd, Yb and Th,
B is at least one element selected from among Ni, Al, Co, Cr, Cu, Fe, Mn, Si, Ti, V, Zn, Zr, Nb, Mo and Pd.

3) alloys with a Laves phase structure, of type AB₂, where:
A is at least one element selected from among Ca, Ce, Dy, Er, Gd, Ho, Hf, La, Li, Pr, Sc, Sm, Th, Ti, U, Y and Zr; and
B is at least one element selected from among Ni, Fe, Mn, Co, Al, Rh, Ru, Pd, Cr, Zr, Be, Ti, Mo, V, Nb, Cu and Zn.

4) AB-type alloys where:
A is at least one element selected from among Ti, Er, Hf, Li, Th, U and Zr; and
B is at least one element selected from among Fe, Al, Be, Co, Cr, Mn, Mo, Nb and V.

5) alloys of body-centered cubic structure, such as described in application U.S. Pat. No. 5,968,291.

1. A method for preparing a material suitable for storing hydrogen
comprising an extreme plastic deformation operation selected from among cold-rolling, quick forging and extrusion bending performed on:
a metallic material selected from among a metal and an alloy containing said metal, or on
a compound containing a metallic material selected from among a metal and an alloy containing said metal into which a hydride of said metal or a hydride of said alloy has been added, and
wherein when the extreme plastic deformation operation is carried out on the metallic material, it is followed by an operation of adding, to the metal material, a hydride of said metal or a hydride of said alloy, and by a dispersing operation.

2. The method according to claim 1, wherein when the extreme plastic deformation operation is carried out on the metallic material, it is followed by an operation of adding, to the metallic material, a hydride of said metal or of a hydride of said alloy, and by a dispersing operation in an inert atmosphere.

3. The method according to claim 1, wherein the metallic material is selected from among magnesium, alloys containing magnesium, alloys containing aluminum, alloys of body-centered cubic structure, alloys of Laves phase structure, AB₅-type alloys, and AB-type alloys.

4. The method according to claim 1, wherein the metallic material or the compound submitted to the extreme plastic deformation operation is in the form of a solid piece.

5. The method according to claim 1, wherein the operation of adding, to the metallic material, the hydride is carried out during the dispersion operation.

6. The method according to claim 1, wherein the operation of adding the hydride to said metallic material is carried out before the dispersion operation.

7. The method according to claim 1, wherein the dispersing operation is followed by a first operation of hydrogenation of said mixture to activate said mixture.

8. The method according to claim 1, wherein the extreme plastic deformation carried out on the compound containing metallic material and hydride is followed by a first operation of hydrogenation of said compound, to activate said compound.

9. The method according to claim 8, wherein a dispersing operation is carried out between the extreme plastic deformation and the first operation of hydrogenation of said compound.

10. The method according to claim 9, wherein the dispersing operation, carried out between the extreme plastic deformation and the first operation of hydrogenation of said compound, is performed in an inert atmosphere.

11. The method according to claim 1, wherein the dispersing operation is carried out by a mechanical grinding shorter than or equal to one hour.

12. The method according to claim 1, wherein the hydride added to the metallic material is obtained by an operation of hydrogenation of said metallic material to activate said metallic material, performed prior to said addition.

13. The method according to claim 1, wherein that the proportion of hydride added to the metallic material ranges between 0.5% and 10% by weight with respect to the total weight of the metallic material.
